(19) United States
(12) Patent Application Publication
(10) Pub. No.: US 2010/0095340 A1
(43) Pub. Date: Apr. 15, 2010

(54) Medical Image Data Processing and Image Viewing System

(75) Inventors: David Ei, Whitmore Lake, MI (US); Peter J. Magsig, Ann Arbor, MI (US); William Braymer, Lakeland, MI (US); Stephen M. Roush, Ann Arbor, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/508,046

(22) Filed: Jul. 23, 2009

Related U.S. Application Data
(60) Provisional application No. 61/104,318, filed on Oct. 10, 2008.

(51) Int. Cl. H04N 7/173

(52) U.S. Cl. 725/116

(57) ABSTRACT

A system enables a diagnosing physician to assess an effect of medical video clip data compression. A medical image data processing and image viewing system includes an acquisition processor for acquiring image data representing a sequence of reduced resolution medical images and corresponding full resolution medical images. An image navigation processor detects, a pause in user navigation through the sequence of reduced resolution medical images and continued presentation of a particular reduced resolution medical image of the sequence on a display. An acquisition control processor automatically initiates acquisition by the acquisition processor of data representing a full resolution medical image corresponding to the particular reduced resolution medical image for presentation on the display in response to a detected pause. A display processor initiates generation of data representing a composite display image including at least one of the particular reduced resolution medical image and the corresponding full resolution medical image.

This is a non-provisional application of provisional application Ser. No. 61/104,318 filed Oct. 10, 2008, by D. Ei et al.

### FIELD OF THE INVENTION

This invention concerns a medical image data processing and image viewing system for automatically presenting individual frames of a reduced resolution video clip at full-resolution, for example, in response to user navigation commands.

### BACKGROUND OF THE INVENTION

Diagnosing physicians frequently view video clips created by medical imaging devices (e.g., an ultrasound machine, X-Ray Angiography unit, MR device, CT scan device). These clips are large and are typically unable to be quickly transferred at full resolution to a physician over limited-bandwidth networks (e.g. Cable/DSL modems commonly used to access the World-Wide Web). Compressing the medical video clips enables them to be transferred relatively quickly, but risks losing valuable image diagnostic information. Further, a compressed video clip does not provide a physician with any indication of what information might have been lost and the physician has no way to evaluate diagnostic impact of the video compression.

Brightness and contrast adjustment of a compressed video clip is also difficult because brightness and contrast adjustment is used to enhance the information that tends to get lost in compression. Known diagnostic imaging systems rely on expensive ultra-high speed networks to transfer video clips at full resolution and require expensive high-speed (e.g. fiber-optic) networks, or are slow to load and play the video clips. The use of video compression and low-bandwidth networks by known systems also results in loss of image fidelity. A system according to invention principles addresses these deficiencies and related problems.

### SUMMARY OF THE INVENTION

A system enables a diagnosing physician to view diagnostic video clips over limited-bandwidth networks as well as individual frames of a clip at full-resolution and to assess an effect of video clip data compression on diagnosis and perform video image brightness and contrast adjustment at full image resolution. A medical image data processing and image viewing system includes an acquisition processor for acquiring image data representing a sequence of reduced resolution medical images and corresponding full resolution medical images. An image navigation processor detects, a pause in user navigation through the sequence of reduced resolution medical images and continued presentation of a particular reduced resolution medical image of the sequence on a display. An acquisition control processor automatically initiates acquisition by the acquisition processor of data representing a full resolution medical image corresponding to the particular reduced resolution medical image for presentation on the display in response to a detected pause. A display processor initiates generation of data representing a composite display image including at least one of the particular reduced resolution medical image and the corresponding full resolution medical image.

### BRIEF DESCRIPTION OF THE DRAWING

FIG. 1 shows a medical image data processing and image viewing system, according to invention principles.

FIG. 2 shows data flow and command interaction in a medical image data processing and image viewing system, according to invention principles.

FIG. 3 shows a user interface display image menu for initiating video clip viewing, according to invention principles.

FIG. 4 shows a user interface display image showing an image frame of a compressed medical video clip, according to invention principles.

FIG. 5 shows a user interface display image showing the image frame of FIG. 4 and activated frame scroll navigation buttons, according to invention principles.

FIG. 6 shows the user interface display image of FIG. 5 and activated change resolution and contrast adjustment controls, according to invention principles.

FIG. 7 shows a user interface display image showing a paused image frame of an uncompressed medical video clip corresponding to the compressed image of FIG. 6, according to invention principles.

FIG. 8 shows the uncompressed image of FIG. 7 with enhanced contrast, according to invention principles.

FIG. 9 shows a downloaded reduced resolution compressed image corresponding to the uncompressed image of FIG. 8 with the enhanced contrast level of FIG. 8 image, according to invention principles.

FIG. 10 shows a user interface display image menu for initiating viewing of a different video clip following viewing the clip of FIG. 9, according to invention principles.

FIG. 11 shows a flowchart of a process performed by a medical image data processing and image viewing system, according to invention principles.

FIG. 12 shows a flowchart of a process performed by a medical image data processing system, according to invention principles.

### DETAILED DESCRIPTION OF THE INVENTION

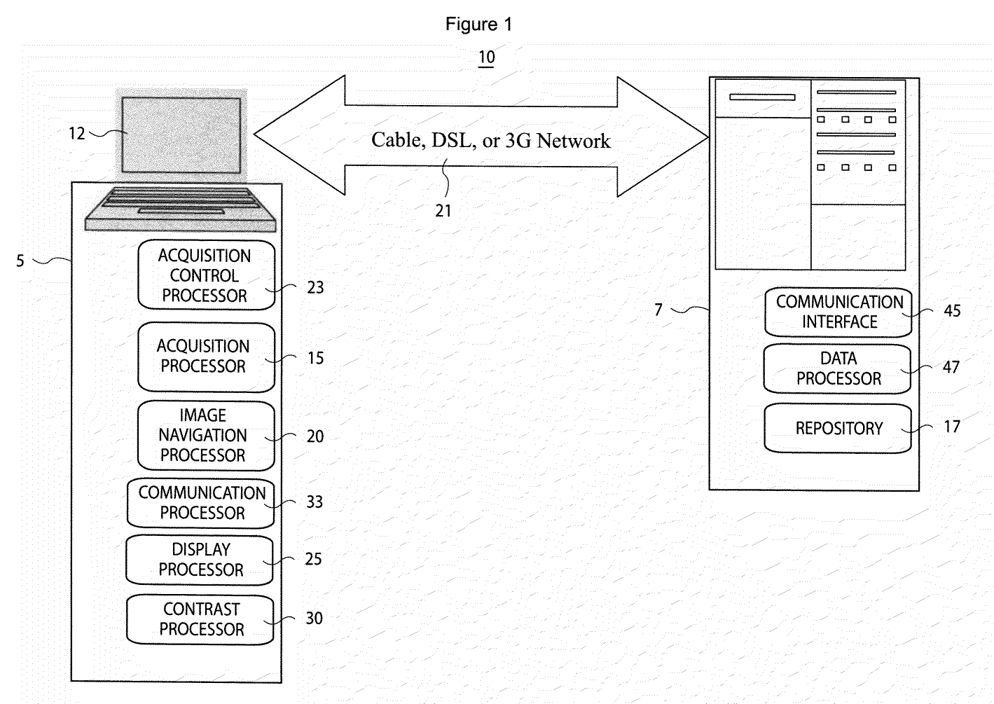

A system enables a diagnosing physician to view diagnostic video clips over limited-bandwidth networks as well as to view individual frames of the clip at full-resolution and to assess the effect of video clip data compression on the diagnosis. The system also enables a physician to perform video image brightness and contrast adjustment at full image resolution. FIG. 1 shows medical image data processing and image viewing system 10. System 10 includes a client device comprising an image or video clip viewer 5 and a PACS medical image/video server 7 that communicate with each other via network 21 comprising a cable, DSL, 3G or other network. PACS server 7 serves both highly-compressed and full-resolution images and video clips. Viewer 5 is able to play both highly-compressed and full-resolution images and video clips. Viewer 5 in one embodiment is browser-based (e.g. using Internet Explorer or Firefox).

System 10 supports sharing of DICOM compatible or non-DICOM compatible medical images, video clips and related data by different computer systems. Client devices 5 (e.g., workstations or portable devices such as notebooks, Personal Digital Assistants, phones) individually include, display 12, acquisition processor 15, image navigation processor 20. acquisition control processor 23, display processor 25, contrast processor 30, communication processor 33 and internal memory (not shown to preserve drawing clarity). Server 7 includes data processor 47, repository 17 and communication interface 45. Display processor 25 provides data representing display images comprising a Graphical User Interface (GUI) for presentation on display 12. At least one repository 17 stores DICOM compatible and/or non-DICOM compatible data and medical image studies and full and reduced resolution (compressed) video clips for multiple patients. A medical image study individually includes multiple image series of a patient anatomical portion which in turn individually include multiple images and may include DICOM structured reports.

Acquisition processor 15 acquires image data representing a sequence of reduced resolution (compressed) medical images (a video clip) and corresponding full resolution medical images. Image navigation processor 20 detects, a pause in user navigation through the sequence of reduced resolution medical images and continued presentation of a particular reduced resolution medical image of the sequence on display 12. Acquisition control processor 23 automatically initiates acquisition by acquisition processor 15 of data representing a full resolution medical image corresponding to the particular reduced resolution medical image for presentation on display 12 in response to a detected pause. Display processor 25 initiates generation of data representing a composite display image including at least one of the particular reduced resolution medical image and the corresponding full resolution medical image. Contrast processor 30 acquires data indicative of user adjusted contrast of the corresponding full resolution medical image in response to user data entry via at least one displayed image. Communication processor 33 initiates communication of the acquired data indicative of user adjusted contrast to a processing device (e.g., server 7) via network 21.

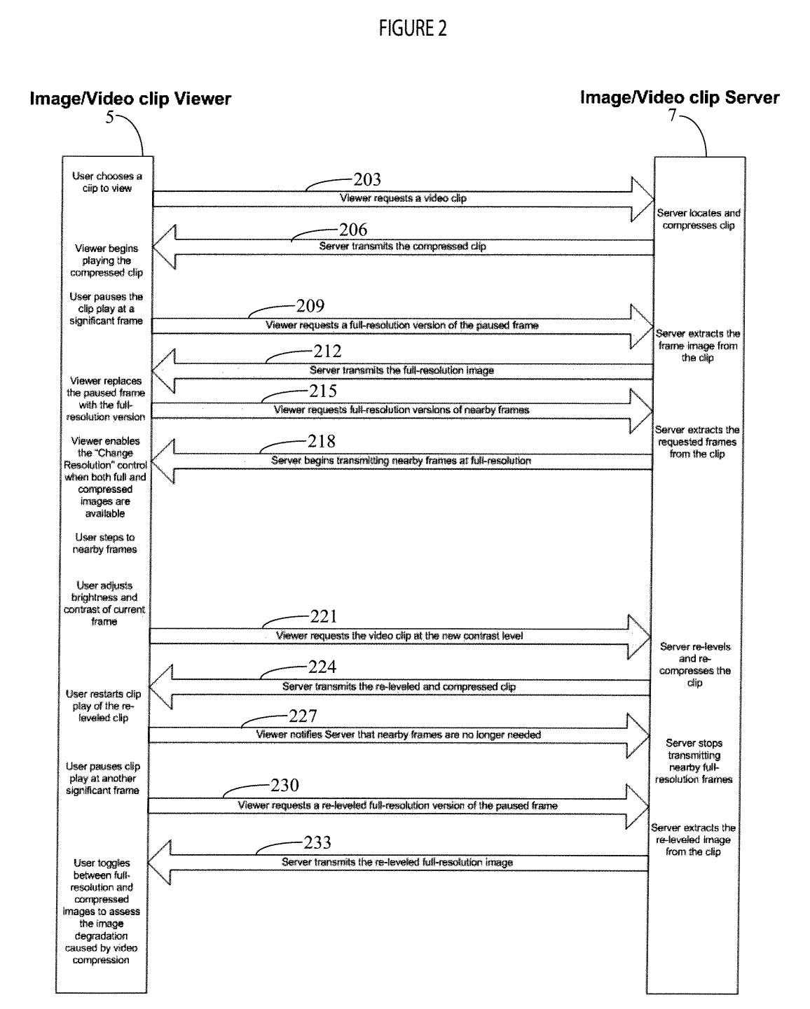

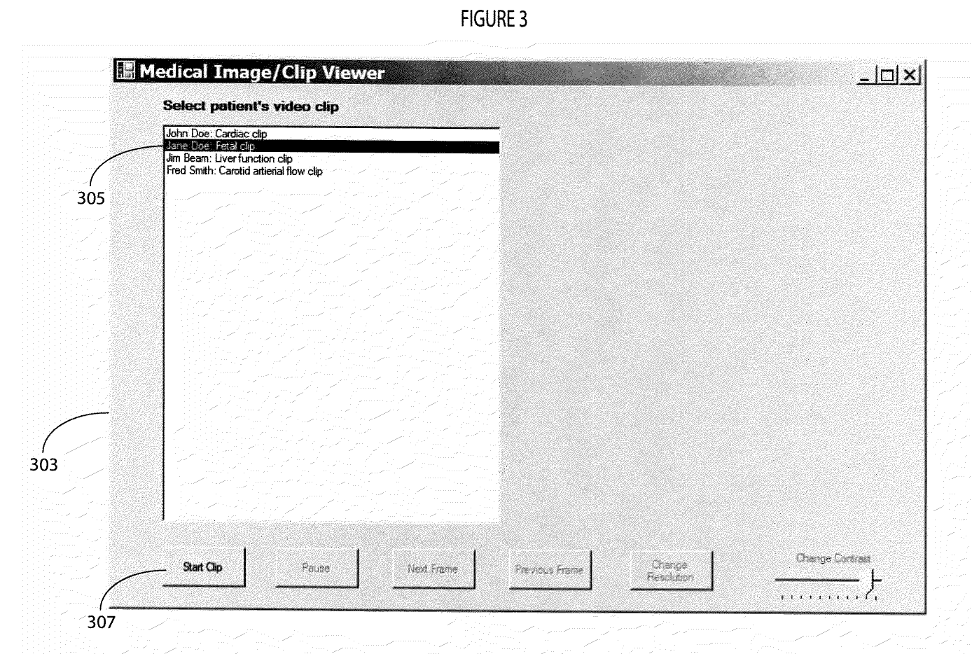

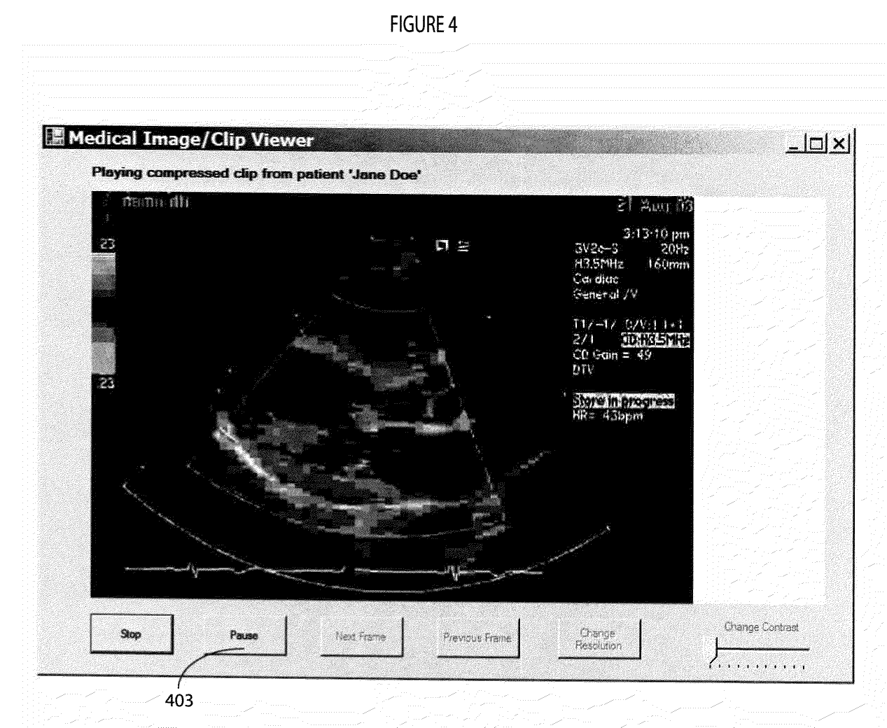

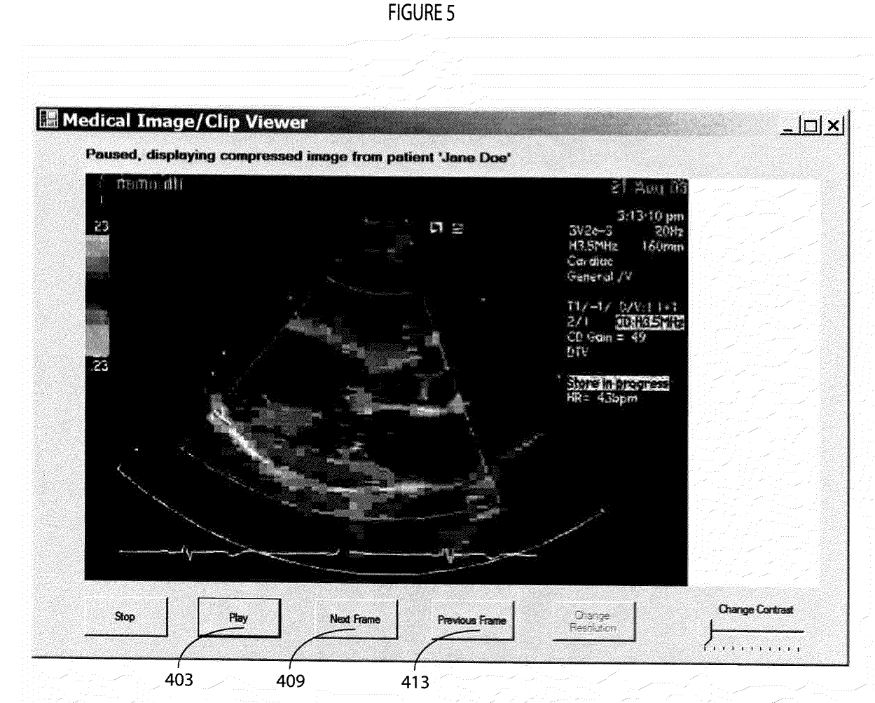

FIG. 2 shows data flow and command interaction in medical image data processing and image viewing system 10 (FIG. 1). In step 203 a user (e.g., a Physician) of client device 5 selects and requests patient diagnostic video clips from PACS server 7 such as by selecting menu option 305 via user interface display image menu 303 of FIG. 3 is presented on display 12. The User starts the compressed clip playing by selecting Start Clip button 307. Device 5 (FIG. 1) communicates a request for a clip to server 7 via network 21 and communication processor 33. In step 206 data processor 47 of PACS server 7 compresses the requested patient video clips and sends them to client device 5 via communication interface 45 and network 21 in response to a received request message. The user selects a particular compressed video clip to play via a menu presented on display 12 and client device 5 begins playing the selected compressed video clip on display 12 as illustrated in FIG. 4. The compressed clip plays in a continuous loop. The user in step 209 pauses the video clip of FIG. 4 to provide the paused user interface display image of FIG. 5 as an area of interest by selecting Pause/Play button 403 to suspend clip play when it reaches a frame that requires closer inspection.

In response to pausing the video clip, navigation buttons 409 and 413 become active to allow the user to scroll to nearby frames. Client device 5 displays the paused compressed reduced resolution image frame of FIG. 5 on display 12 and automatically requests a full-resolution version of the paused image frame from PACS server 7 in a message identifying the paused frame communicated to server 7 by processor 33 via network 21. Data processor 47 of server 7 derives data representing the full-resolution image frame corresponding to the identified paused compressed reduced resolution image frame. Specifically data processor 47 extracts data representing the full-resolution image frame (and nearby frames) from a full-resolution video clip of the corresponding compressed reduced resolution clip including the paused frame of FIG. 5. Server 7 uses communication interface 45 to automatically communicate the extracted full-resolution image frames to device 5 in step 212 and device 5 displays the full-resolution image frame on display 12 substantially as soon as it is received.

Device 5 in step 212 automatically begins downloading the paused frame from server 7 at full-resolution as well as full-resolution versions of frames nearby the paused frame in step 218 in response to a message request for full-resolution versions of the nearby frames communicated from device 5 to server 7 in step 215 using communication processor 33. Device 5 automatically updates display 12 to replace the paused compressed reduced resolution image frame with an acquired corresponding uncompressed full-resolution image frame.

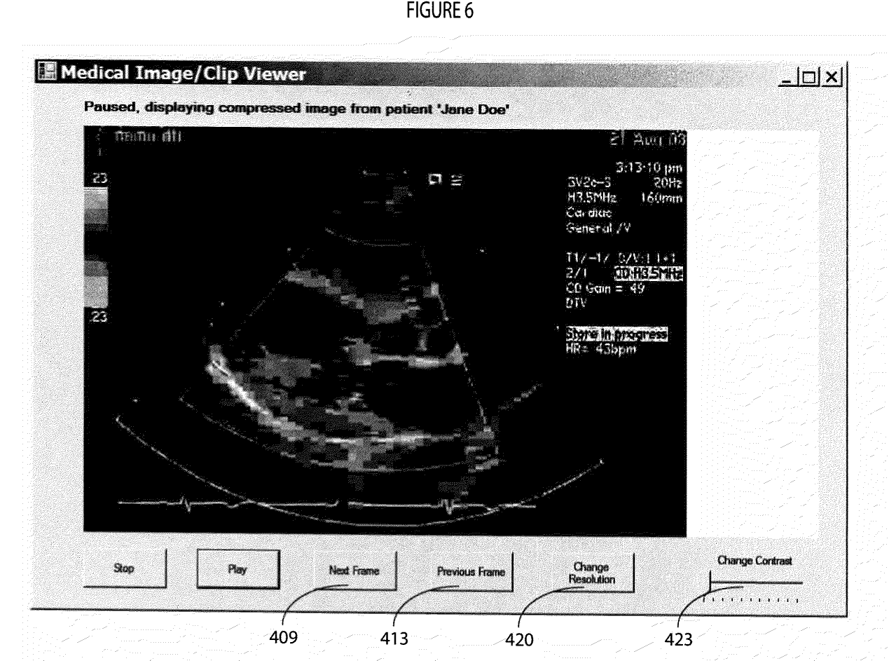

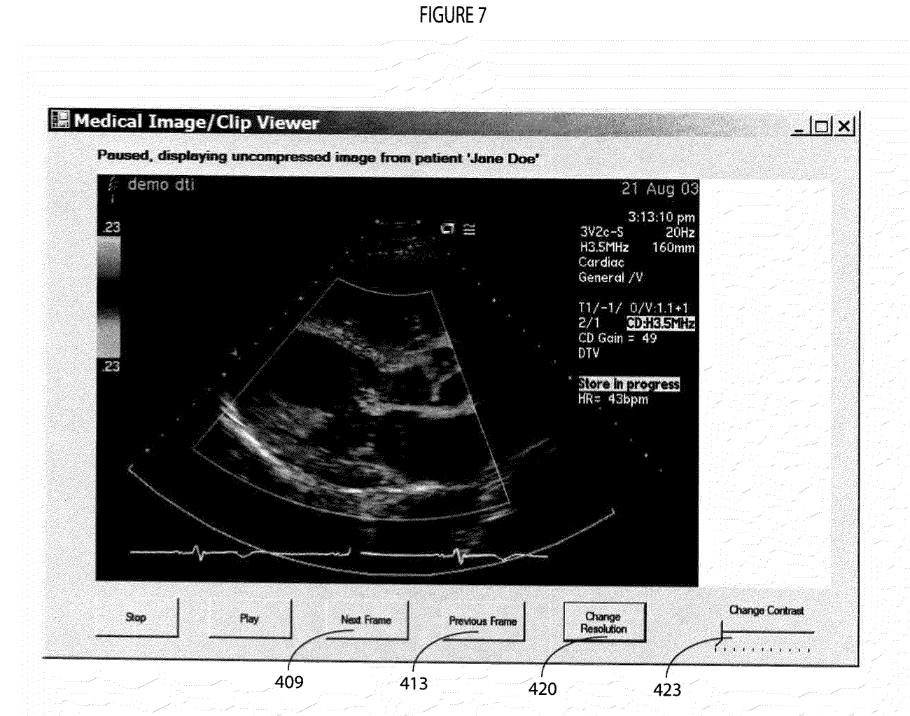

FIG. 6 shows the user interface display image of FIG. 5 but with change resolution button 420 and contrast slider adjustment 423 activated by device 5 in response to acquisition and availability of the uncompressed full-resolution paused image and nearby image frames. A brightness and contrast adjustment process allows a user to adjust the contrast of a full-resolution image via slider adjustment 423. Changes in contrast are automatically transmitted back to server 7 which re-levels the entire clip at the new contrast setting and automatically sends the newly-leveled and recompressed clip back to device 5. When play is resumed, the re-leveled clip is played. A user is advantageously able to toggle between an uncompressed full-resolution paused image and the corresponding compressed reduced resolution image, using button 420 to identify the impact of reduced resolution on both image quality and diagnostic value of an image. In response to user selection of activated change resolution button 420, an uncompressed full-resolution image corresponding to the paused image is displayed as shown in FIG. 7. Specifically, FIG. 7 shows a user interface display image showing a paused image frame of an uncompressed medical video clip corresponding to the compressed image of FIG. 6 including activated change resolution button 420 and contrast adjustment button 423. A user is able to scroll to nearby full resolution frames using next frame and previous frame buttons 409 and 413 in full-resolution mode set by button 420. Buttons 409 and 413 are activated in full-resolution mode in response to full-resolution versions of the nearby frames being acquired from server 7 and being available in device 5.

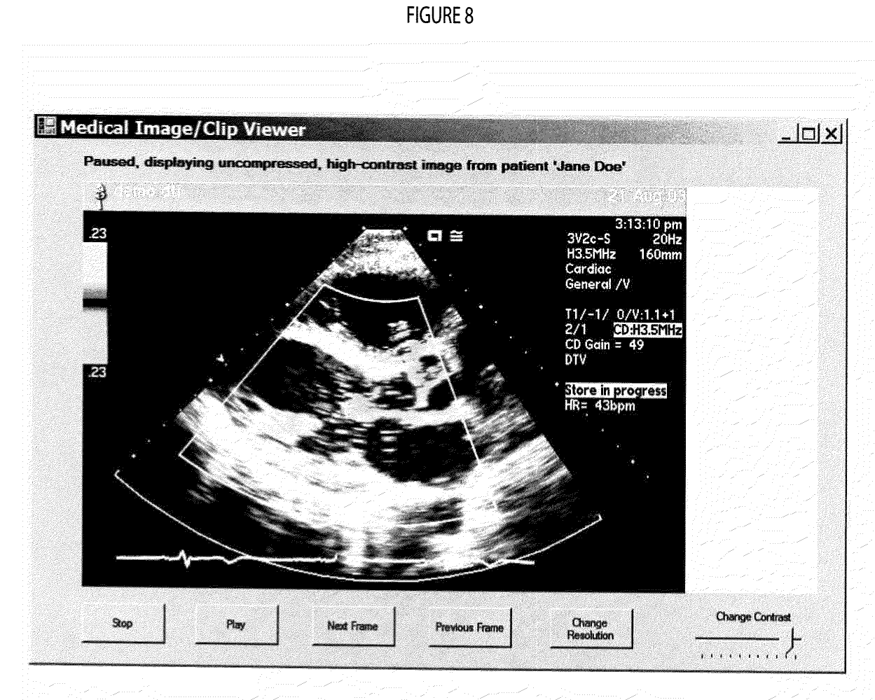

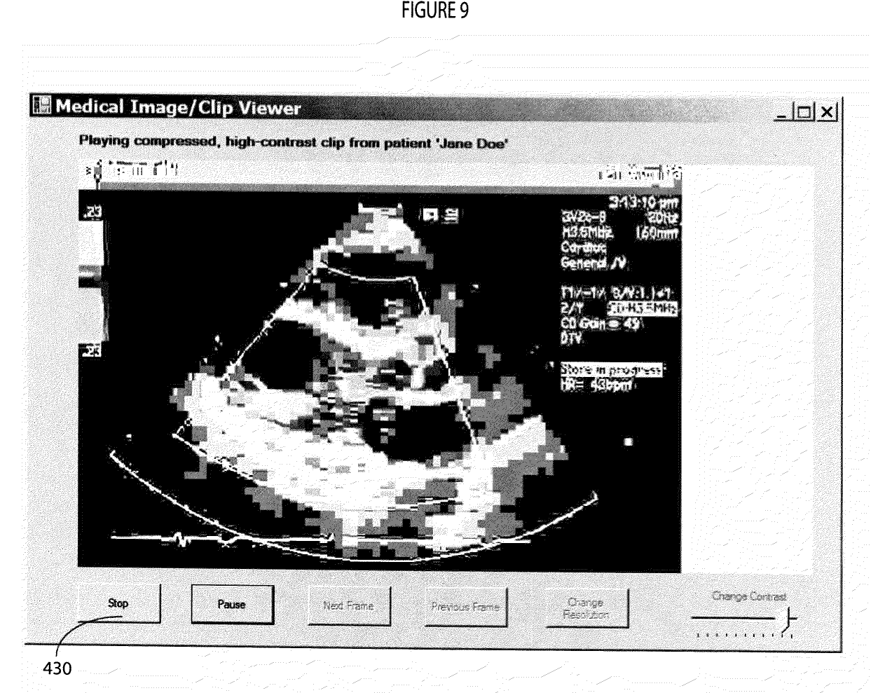

A user adjusts the contrast of the paused image frame of FIG. 7 using adjustment control 423 to make clinically relevant details of the image stand out and provide the image of FIG. 8 with enhanced contrast. A user also changes the brightness of the displayed image using a control (not shown to preserve drawing clarity). In response to user adjustment of contrast or brightness of the displayed uncompressed full-resolution image, device 5 automatically initiates downloading the compressed video clip including the paused image at the new contrast levels. In step 224 device 5 automatically begins downloading the compressed video clip at the new contrast levels from server 7 in response to a message requesting the compressed video clip at the changed contrast and brightness levels sent in step 221. Device 5 communicates the message in step 221 to server 7 using communication processor 33. Data processor 47 in server 7 adjusts contrast levels of the corresponding uncompressed full-resolution video clip and compresses the clip at the adjusted levels and communicates the compressed clip at the new contrast levels via interface 45 to device 5. A user re-starts play of the video clip presented on display 12 with the new contrast levels. FIG. 9 shows a downloaded reduced resolution compressed image corresponding to the uncompressed image of FIG. 8 with the enhanced contrast level of FIG. 8 image.

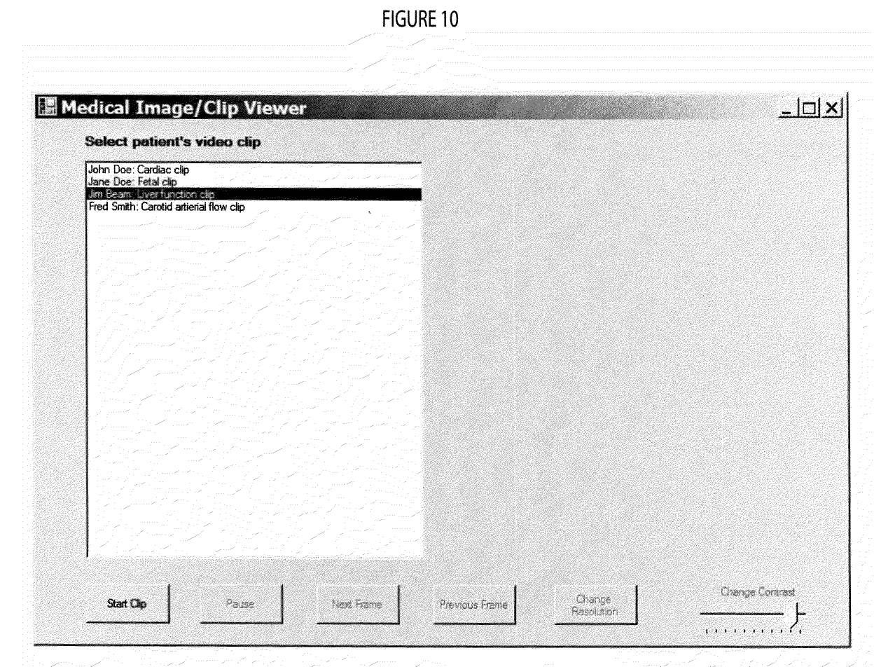

In step 227 device 5 communicates a message to server 7 indicating nearby images of a paused frame are no longer needed and server 7 terminates communication of nearby frames. In step 230 device 5. In response to the user pausing the re-started compressed reduced resolution video clip with enhanced contrast levels at another image of interest, device 5 in step 230 automatically initiates downloading the paused frame from server 7 at full-resolution with the enhanced contrast levels as well as full-resolution versions of frames nearby the paused frame. Device 7 identifies and extracts the paused frame and nearby frames with full resolution and enhanced contrast levels from a full resolution clip having the adjusted enhanced contrast levels in response to a message request automatically communicated from device 5 to server 7 in step 230 using communication processor 33. Data processor 47 of device 7 identifies and extracts the paused frame and nearby frames with full resolution and enhanced contrast levels from a full resolution clip having the adjusted enhanced contrast levels in response to the message request automatically communicated from device 5 to server 7 in step 230 using communication processor 33. Device 5 automatically updates display 12 to replace the paused enhanced contrast compressed reduced resolution image frame with an acquired corresponding enhanced contrast uncompressed full-resolution image frame. A user is able to advantageously toggle between full and corresponding reduced resolution images to see if there is any diagnostically significant difference between the images using change resolution button 420 of FIG. 6. When the user has finished viewing the clip, the user presses Stop button 430 (FIG. 9) and selects medical images of a new patient to view. FIG. 10 shows a user interface display image menu for initiating viewing of a different video clip following viewing the clip of FIG. 9.

System 10 enables networks of limited-bandwidth to view medical images and clips and enables individual image frames to be viewed at full-resolution. Spare bandwidth is used to pre-fetch frames before and after a paused frame. When full resolution images of nearby frames become available, additional buttons are enabled that allow the user to step to nearby frames. The system reduces time to transfer compressed video clips to a diagnosing user and the user may play the clip, or pause it and view individual frames at full-resolution. System 10 also enables brightness and contrast adjustment to be performed on a full-resolution image and applied to an entire video clip. The user is able to also perform brightness and contrast adjustment on a single-frame full-resolution image, and play the compressed clip at the new window-level settings. Further, a physician by toggling between full and reduced resolution images, is able to assess the effect of video clip data compression and its impact on diagnosis. The system advantageously enables a diagnosing user to review diagnostic video clips acquired over inexpensive and widely available networks and view pertinent frames at full-resolution, and assess whether a diagnosis is being compromised by the image compression. User interface buttons enable a user to examine nearby frames at high-resolution. The system advantageously displays a few full-resolution frames from a video consisting of a large collection of compressed frames. The system also advantageously combines compressed video clips with individual uncompressed frames. In operation, a user at home receives a phone call from a referring user requesting review of an ultrasound or other imaging modality video clip. The user connects to a hospital PACS server using a home PC via a cable or DSL modem and reviews the diagnostic images and makes a diagnosis over the phone.

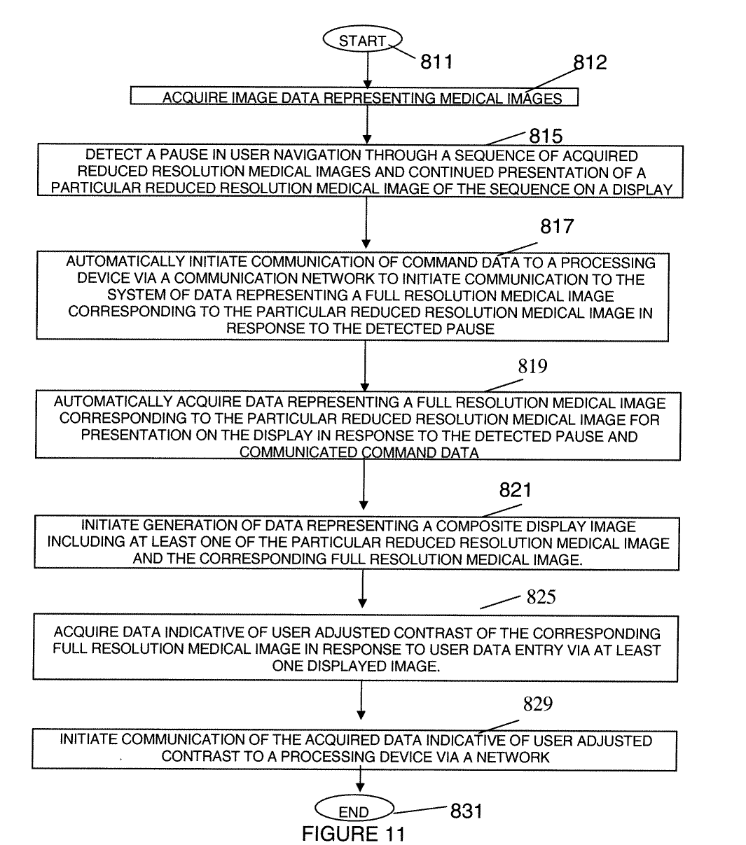

FIG. 11 shows a flowchart of a process performed by medical image data processing and image viewing system in client device 5 of system 10 (FIG. 1). In step 812 following the start at step 811, acquisition processor 15 acquires image data representing medical images. Image navigation processor 20 in step 815 automatically detects, a pause in user navigation through a sequence of acquired reduced resolution medical images and continued presentation of a particular reduced resolution medical image of the sequence on display 12. Image navigation processor 20 detects the pause as exceeding a first predetermined time duration threshold. Image navigation processor 20 detects termination of the pause by time duration of the pause being within a second predetermined time duration threshold and initiates termination of acquisition by acquisition processor 15 of the data representing the full resolution medical image corresponding to the particular reduced resolution medical image.

In step 817 communication processor 33 automatically communicates command data to a processing device (server 7) via a communication link (e.g., network 21) to initiate communication to device 5 from server 7 of data representing the full resolution medical image corresponding to the particular reduced resolution medical image in response to the detected pause. In step 819 acquisition control processor 23 automatically initiates acquisition by acquisition processor 15 of data representing a full resolution medical image corresponding to the particular reduced resolution medical image for presentation on display 12 in response to a detected pause as a pre-fetch operation for storage in local memory. Acquisition control processor 23 also automatically initiates acquisition by acquisition processor 15 of data representing a full resolution medical image corresponding to at least one nearby image of the particular reduced resolution medical image for presentation on display 12 in response to a detected pause. Further, image navigation processor 20 enables a user to scroll to the full resolution medical image corresponding to at least one nearby image. Display processor 25 in step 821 automatically initiates generation of data representing a composite display image including at least one of the particular reduced resolution medical image and the corresponding full resolution medical image. The composite display image includes a user selectable image element enabling user toggling between display of the particular reduced resolution medical image and the corresponding full resolution medical image. The composite display image includes a user selectable image element enabling a user to compare the particular reduced resolution medical image with the corresponding full resolution medical image and includes a user selectable image element enabling a user to initiate communication of the particular reduced resolution medical image to a remotely located medical worker.

Contrast processor 30 in step 825 acquires data indicative of user adjusted contrast of the corresponding full resolution medical image in response to user data entry via at least one displayed image. In step 829 communication processor 33 automatically communicates the acquired data indicative of user adjusted contrast to server 7 via network 21. Acquisition processor 15 acquires image data representing a reduced resolution medical image processed in response to the acquired data indicative of user adjusted contrast and automatically communicated by server 7 to acquisition processor 15. The process of FIG. 11 terminates at step 831.

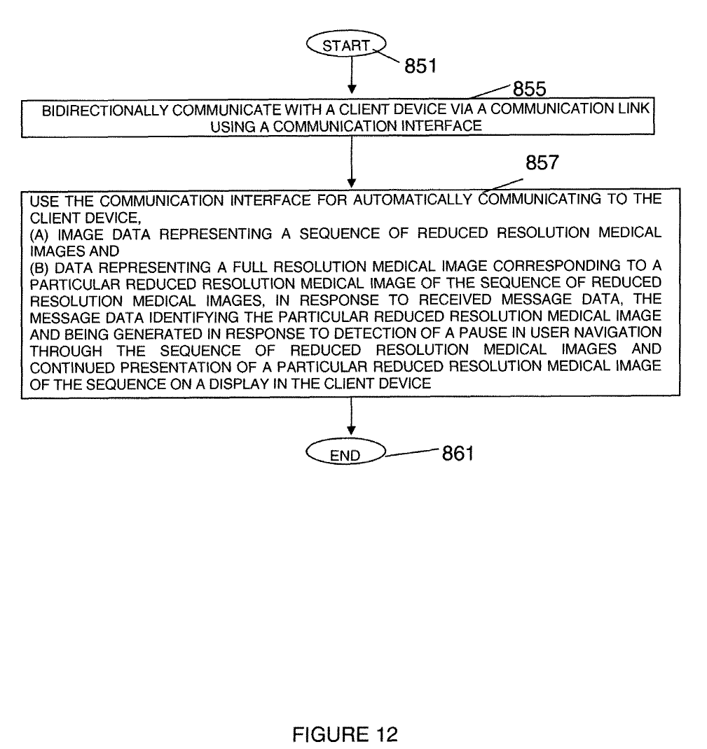

FIG. 12 shows a flowchart of a process performed by a medical image data processing system in server 7 of system 10 (FIG. 1). In step 855 following the start at step 851, communication interface 45 bidirectionally communicates with client device 5 via a communication link (e.g., network 21). In step 857 data processor 47 uses communication interface 45 for automatically communicating to client device 5, (a) image data representing a sequence of reduced resolution medical images and (b) data representing a full resolution medical image corresponding to a particular reduced resolution medical image of the sequence of reduced resolution medical images, in response to received message data. The message data identifies the particular reduced resolution medical image and is generated in response to detection of a pause in user navigation through the sequence of reduced resolution medical images and continued presentation of a particular reduced resolution medical image of the sequence on display 12 in client device 5. Data processor 47 extracts the full resolution medical image corresponding to the particular reduced resolution medical image from a sequence of full resolution medical images corresponding to the sequence of reduced resolution medical images in response to the data identifying the particular reduced resolution medical image.

Data processor 47 provides the image data representing the sequence of reduced resolution medical images by compressing data representing a sequence of full resolution medical images corresponding to the sequence of reduced resolution medical images. Data processor 47 automatically communicates to client device 5, data representing at least one full resolution medical image corresponding to at least one nearby image of the particular reduced resolution medical image. Also communication interface 45 acquires data indicative of user adjusted contrast of the corresponding full resolution medical image. Data processor 47 processes data representing a sequence of full resolution medical images corresponding to the sequence of reduced resolution medical images as well as data representing the sequence of reduced resolution medical images in response to the acquired data indicative of user adjusted contrast. Data processor 47 provides contrast adjusted image data representing the sequence of reduced resolution medical images by compressing the processed data representing the sequence of full resolution medical images. The process of FIG. 12 terminates at step 861.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a user interface processor and enabling user interaction with a processor or other device and associated data acquisition and processing functions.

The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-12 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system may be used for any application in which a high-resolution video clip contains valuable information that may be compromised by video compression and relevant information tends to be localized in a small segment of the clip. Further, the processes and applications may, in alternative embodiments, be located on one or more (e.g., distributed) processing devices on the network of FIG. 1. Any of the functions and steps provided in FIGS. 1-12 may be implemented in hardware, software or a combination of both and client device 5 and server 7 may comprise other distributed or combined devices such as a PC or other computer or multiple computers.

What is claimed is:

1. A medical image data processing and image viewing system, comprising:
an acquisition processor for acquiring image data representing medical images;
an image navigation processor for detecting, a pause in user navigation through a sequence of acquired reduced resolution medical images and continued presentation of a particular reduced resolution medical image of said sequence on a display;
an acquisition control processor for automatically initiating acquisition by said acquisition processor of data representing a full resolution medical image corresponding to said particular reduced resolution medical image for presentation on said display in response to a detected pause; and
a display processor for initiating generation of data representing a composite display image including at least one of said particular reduced resolution medical image and the corresponding full resolution medical image.

2. A system according to claim 1, wherein
said image navigation processor detects said pause as exceeding a first predetermined time duration threshold.

3. A system according to claim 1, wherein
said image navigation processor detects termination of said pause and initiates termination of acquisition by said acquisition processor of said data representing said full resolution medical image corresponding to said particular reduced resolution medical image.

4. A system according to claim 3, wherein
said image navigation processor detects termination of said pause by time duration of said pause being within a second predetermined time duration threshold.

5. A system according to claim 1, wherein
said composite display image includes a user selectable image element enabling user toggling between display of said particular reduced resolution medical image and said corresponding full resolution medical image.

6. A system according to claim 1, including
a contrast processor for acquiring data indicative of user adjusted contrast of said corresponding full resolution medical image in response to user data entry via at least one displayed image.

7. A system according to claim 6, including
a communication processor for initiating communication of the acquired data indicative of user adjusted contrast to a processing device via a network.

8. A system according to claim 7, wherein
said acquisition processor acquires image data representing a reduced resolution medical image processed in response to the acquired data indicative of user adjusted contrast and automatically communicated by said processing device to said acquisition processor.

9. A system according to claim 8, wherein
said display processor automatically initiates generation of data representing a composite display image including the reduced resolution medical image processed in response to the acquired data indicative of user adjusted contrast in response to acquisition of the reduced resolution medical image processed by said acquisition processor.

10. A system according to claim 1, wherein
said composite display image includes a user selectable image element enabling a user to compare said particular reduced resolution medical image with said corresponding full resolution medical image and including
a user selectable image element enabling a user to initiate communication of said particular reduced resolution medical image to a remotely located medical worker.

11. A system according to claim 1, wherein
said acquisition control processor automatically initiates acquisition by said acquisition processor of data representing a full resolution medical image corresponding to said particular reduced resolution medical image as a pre-fetch operation for storage in local memory.

12. A system according to claim 1, including
a communication processor for automatically initiating communication of command data to a processing device via a communication network to initiate communication to said system of data representing said full resolution medical image corresponding to said particular reduced resolution medical image in response to said detected pause.

13. A system according to claim 1, wherein
said acquisition control processor automatically initiates acquisition by said acquisition processor of data representing a full resolution medical image corresponding to at least one nearby image of said particular reduced resolution medical image for presentation on said display in response to a detected pause and
said image navigation processor enables a user to scroll to said full resolution medical image corresponding to at least one nearby image

14. A medical image data processing system, comprising:
a communication interface for bidirectionally communicating with a client device via a communication link;
a data processor for using said communication interface for automatically communicating to the client device,
(a) image data representing a sequence of reduced resolution medical images and
(b) data representing a full resolution medical image corresponding to a particular reduced resolution medical image of said sequence of reduced resolution medical images, in response to received message data, said message data identifying said particular reduced resolution medical image and being generated in response to detection of a pause in user navigation through said sequence of reduced resolution medical images and continued presentation of a particular reduced resolution medical image of said sequence on a display in the client device.

15. A system according to claim 14, wherein
said data processor extracts said full resolution medical image corresponding to said particular reduced resolution medical image from a sequence of full resolution medical images corresponding to said sequence of reduced resolution medical images in response to said data identifying said particular reduced resolution medical image.

16. A system according to claim 14, wherein
said data processor automatically communicates to the client device, data representing at least one full resolution medical image corresponding to at least one nearby image of said particular reduced resolution medical image.

17. A system according to claim 14, wherein
said communication interface acquires data indicative of user adjusted contrast of said corresponding full resolution medical image and
said data processor processes data representing the sequence of reduced resolution medical images in response to the acquired data indicative of user adjusted contrast.

18. A system according to claim 14, wherein
said communication interface acquires data indicative of user adjusted contrast of said corresponding full resolution medical image and
said data processor processes data representing a sequence of full resolution medical images corresponding to said sequence of reduced resolution medical images in response to the acquired data indicative of user adjusted contrast and provides contrast adjusted image data representing said sequence of reduced resolution medical images by compressing the processed data representing the sequence of full resolution medical images.

19. A system according to claim 14, wherein
said data processor provides said image data representing said sequence of reduced resolution medical images by compressing data representing a sequence of full resolution medical images corresponding to said sequence of reduced resolution medical images.

20. A system according to claim 14, wherein
said communication link comprises a communication network.

21. A system according to claim 14, including
an image data processor for re-generating a sequence of reduced resolution medical images in response to data indicative of user adjusted contrast acquired from the client device.

22. A system according to claim 20, wherein
said data processor automatically communicates to the client device data representing the re-generated sequence of reduced resolution medical images.

23. A method for medical image data processing and image viewing system, comprising the activities of:
acquiring image data representing medical images;
detecting a pause in user navigation through a sequence of reduced resolution medical images and continued presentation of a particular reduced resolution medical image of said sequence on a display;
automatically acquiring data representing a full resolution medical image corresponding to said particular reduced resolution medical image for presentation on said display in response to a detected pause; and
initiating generation of data representing a composite display image including at least one of said particular reduced resolution medical image and the corresponding full resolution medical image.
